(19) United States
(12) Patent Application Publication
(10) Pub. No.: US 2007/0027729 A1
(43) Pub. Date: Feb. 1, 2007

(54) Simultaneous scheduling of multiple appointments

(75) Inventors: Sebastien Van Bruaene, Mortsel (BE); Henk Vansteenkiste, Gent (BE); Wannes Kieckens, Gent (BE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: AGFA-GEVAERT, Mortsel (BE)

(21) Appl. No.: 10/569,890

(22) PCT Filed: Aug. 31, 2004
(86) PCT No.: PCT/EP04/51971

§ 371 Date: Jun. 15, 2006

(30) Foreign Application Priority Data
Sep. 1, 2003 (EP) 031026834

(51) Int. Cl. G06F 9/44

(52) U.S. Cl. 705/7

(57) ABSTRACT

A scheduling method is desclosed which allows simultaneous scheduling of multiple appointments. The method provides for grouping and chronological ordering of a plurality of exams for a patient according to attributes and allows the plurality of exams to be forwarded to a scheduling system for simultaneously scheduling all exams such that restrictions imposed during the grouping process are met.

### FIELD OF THE INVENTION

The present invention relates to a method and system for scheduling appointments. More specifically the invention is related to simultaneous scheduling of multiple appointments.

### BACKGROUND OF THE INVENTION

In a clinical environment, a patient may need to undergo several exams. An exam may be a physical examination, a consultation, an exertion test, a blood test, a scan by a CT or MR scanner, an X-ray etc. Each exam may need specific resources, which availability has to be checked carefully, in order to schedule each exam. The process of scheduling may be time consuming for the operator.

The scheduling methods currently available provide means for scheduling procedures or individual exams consecutively. A procedure is then transformed in a set of appointments, by a scheduling process, by specifying a precise time for each exam in the procedure. For each exam the whole scheduling process has to be executed to obtain an appointment. In some cases a patient has to have several exams on a regular or repeated basis or has to undergo a number of different exams. For all of these exams a new appointment has to be planned. Once this appointment is scheduled, the patient may receive a letter for this specific appointment. For five related appointments, the patient may receive then five different letters. Therefore a need exists for a scheduling method that allows scheduling of multiple appointments without repeating the entire scheduling process.

### OBJECTS OF THE INVENTION

It is an object of the invention to schedule a plurality of exams by less time consuming interaction of the operator.

It is another object of the invention to schedule a plurality of order sessions simultaneously.

### SUMMARY OF THE INVENTION

The above objects are realised by a scheduling method having the specific features set out in claim 1. Specific features for preferred embodiments of the invention are set out in the dependent claims. Advantages and embodiments of the present invention will become apparent from the following description and drawings.

### BRIEF DESCRIPTION OF THE DRAWINGS

FIGS. 1A, 1B and 1C show a flow diagram of the scheduling process of the present invention.

### DETAILED DESCRIPTION OF THE INVENTION

According to the invention, exams may be arranged in a batch. Each batch refers to one or more exams starting on a single day. One attribute of the batch may be the optional specification of a minimum or maximum time between the exams within the batch. For the first exam in the batch a start time is preferably specified. Although all the exams within a batch have to start on a single day, it is possible that one of these exams has a duration extending over two or more days. A batch may also contain just one exam.

Exams or batches may also be arranged in treatments. A treatment may be defined as at least two batches or even two exams or one exam and one batch, to be performed on at least two different days. One of the attributes of a treatment may be the specification a preferred period, when all exams within the treatment have to start. A period may be specified by a start date and an end date, or more informally by a specification such as “next week”, “the next 4 days” etc. A period specified by a start date and end date is more exactly referred to as a “date period”. Another attribute of a treatment is the recurrence of the batches. As such, one embodiment of a treatment is a batch with recurrence. In such case, the batch may be defined once, the multiplicity for this batch within the treatment is defined, e.g. 5, and the interval between the subsequent, substantially similar batches may be given as for example 4 days. A treatment with a recurrence of one, may degenerate in a batch having all exams starting on one single day.

One or more treatments or one or more batches or one or more exams may be arranged in a set, preferably to be executed on one service or department within a hospital.

A “procedure” is defined in this context as a request for an exam, one or more batches of exams or one or more treatments. A procedure requires the allocation of at least one resource for a certain duration of time. A resource typically refers to a room where the patient will be examined, a device for examining the patient or a required person. The required person may be a medical person such as a physician, a radiologist, an anaesthetist; or a paramedical person such as a nurse, a physiotherapist etc.

The term “procedure” is thus used to include an ‘exam’, a ‘batch’, a ‘treatment’ and a ‘set’. In most cases an exam within an order session is linked to one specific service or department, which may be the only department within the hospital where that specific exam may be performed. If the hospital or hospital association has several departments where the same exam may be performed, the prescribing physician may have the option to select freely one of the available departments. This may be achieved by linking to each specific exam type or exam code in the HIS or RIS system the single or several departments where this exam may be performed. In database systems, radiology information systems (RIS) or hospital information systems (HIS), each specific exam type may have a unique code, referred to as exam code, assigned to it. The RIS or HIS system preferably stores internally this code, but displays a human readable expression for the user of the information system, preferably in the language of the operator.

In cases where the exam may be performed in several departments, it may be possible to give the user one single most suitable option, to offer him the most suitable default with the option to change this choice or even to change this default, or to offer the user a completely free choice. If an exam has no pre-defined service linked to it, the user may have to select a specific service.

A prescribing physician, who prescribes one or more exams for a patient, may define an “order session”. An order session is a request for a procedure, such as an exam or batch or treatment, or a series of procedures. The order session may thus contain just one exam, or a plurality of exams, one or more batches or one or more treatments, optionally with a recurrence.

In an order session the procedures or exams are usually not specified with a precise start time for one or each of the exams. An order session may however specify a preferred period such as a period of two weeks, in which all the exams of the order session have to be performed. An order session may also specify the requirement that Mondays have to be excluded for the exams.

An order session may be transformed in a set of appointments, by a scheduling process. The scheduling process will specify a precise time for each exam in the order session.

According to the present invention a scheduling method is provided which allows simultaneous scheduling of multiple appointments. The method according to the invention enables grouping and chronological ordering of a plurality of exams for one patient, along with attributes, such that the plurality of exams may be forwarded to a scheduling system for scheduling all exams simultaneously. The scheduling process will then compute a solution for the composed set of exams, i.e. for each exam a suitable start time is fixed, such that all restrictions, imposed during the grouping process, are met and such that the resources required for each specific exam are really available for that exam, during the time slot assigned to that exam by the scheduling process. Grouping of multiple exams may even be done for one patient and different prescribing or ordering physicians. If a first ordering physician created a first order session for a patient, and a second ordering physician created a second order session for this patient, both order sessions may appear for scheduling, and all or a subset of their exams could end up in one set by the process according to the current invention. The system according to the current invention mav display a list of all procedures to be scheduled. As such, the system displays a list of all the procedures to be scheduled. Optionally the operator can use parameters such as the specification of a department, the specification of one order session or the specification of an order type to reduce the number of procedures displayed. A database, storing the order sessions and procedures, may assign an order type to each procedure, or more specifically to each exam. This order type may be used for restricting, also referred to as “filtering”, long lists of order sessions, procedures or exams. It is useful to have restricted lists for validating and scheduling. Also for selection of a first order session, it may be useful to browse through a restricted list, rather than through a full list of order sessions that have not been converted into appointments yet. This order type may be seen as a purely administrative code, e.g. for a CT scanner, an MR scanner, or an ultrasound (US) device. The database may provide that the hospitals are free to define the layout of such code, e.g. in the first characters they could code the name of the department, and in the following characters the specific type of exam, e.g. RAD_CT for a CT scanner in the RADiology department.

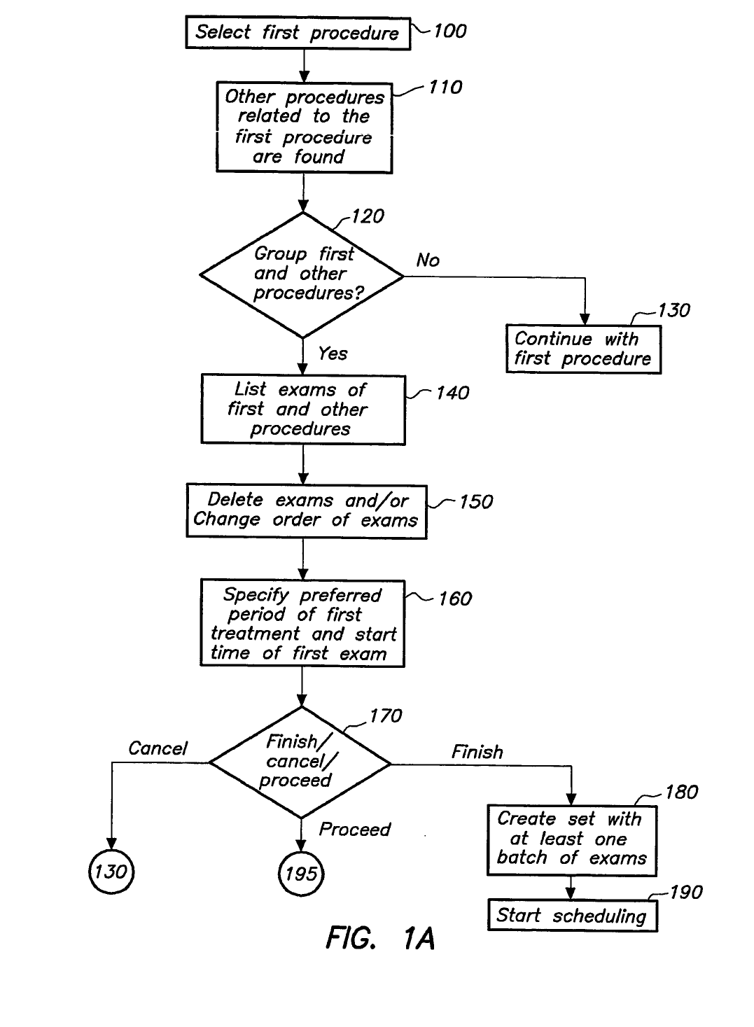

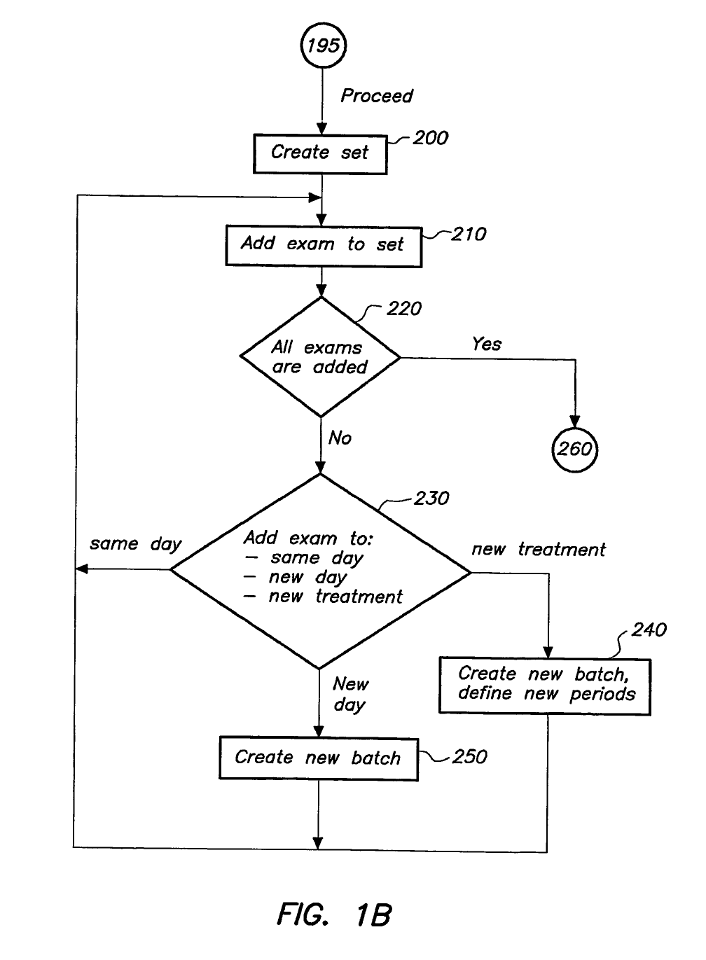

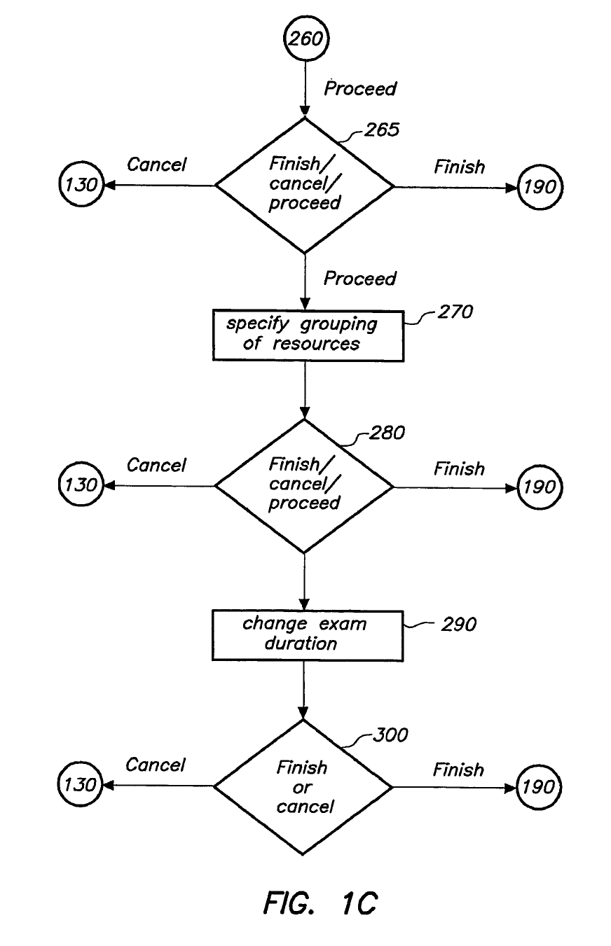

As shown in FIG. 1 in a first step 100, the operator or user selects a first procedure from the displayed list of procedures to schedule that procedure for a specific patient. According to step 110, the system will then check if there are other procedures for this patient and displays a list of all other procedures to be scheduled for that patient. Different procedures for one specific patient are referred to as “related procedures”. Again, the operator can optionally use parameters such as the specification of the department, one order session or one specific order type to reduce the number of procedures displayed for that patient. As such, when the operator selects one order session for a patient for planning it into one appointment or a set of appointments, the system checks according to step 110 whether there are other order sessions or exams for this patient. According to step 120, the system asks the operator whether the first procedure and the other related procedures have to be grouped. If not, the operator can continue in step 130 with the first selected procedure and start scheduling this single procedure. In case the operator thus opts for not grouping the order sessions or exams, the order session has preferably to be transformed into one or more appointments in the usual way, without the production of a set of multiple related exams. If in step 120 the operator decides to group the procedures the system displays in step 140 a list of all individual exams within the first and other procedures. This system allows the operator in step 150 to delete exams from the first and other related procedures. As such, the operator has the option to de-select all exams within the selected order sessions, which have not to enter the final set for scheduling. Furthermore in step 150 the operator can specify in which sequence he wants to plan the remaining exams, i.e. the exams he did not delete. By changing the order of the exams, the operator has the option to impose a chronological sequence on the different exams.

All selected order sessions, i.e. the first selected order session and the other selected order session or sessions have been split in singular exams in step 140, and each exam is separately and chronologically listed on the display for the operator. Although order sessions usually are not scheduled yet, they may still have some chronology. Preferably, each order session lists the required exams in the order they have to be performed. However, the operator has according to step 150 the capability to re-order or change the chronological order of the exams.

In step 160 the operator can select a preferred date period for the first batch or treatment of the procedure or first exam and can indicate the start time of the first exam of this batch or treatment. More preferably, the user specifies a time frame for the first exam. A time frame is defined by a start time HH:MM and an end time hh:mm within one day, wherein hh:mm≧HH:MM. The selection of a preferred date period may be done by specifying a start date and an end date for a period within which all selected exams of the treatment have to be performed. According to a preferred embodiment, the “preferred period” relates to one single treatment.

In step 170 the operator can proceed to step 200, stop or finish the simultaneous scheduling process via step 180 or cancel via step 130, as discussed herein before. If the simultaneous scheduling process is finished in step 170, a set comprising at least one batch of exams is created in step 180. This means that all exams, which were present in the first selected procedure (step 100) and the other procedures (step 110) related to the first procedure, except for the exams deleted (step 150) afterwards, will be entered in a batch, according to step 180. This batch is then entered in the created set. The user may specify manually or the system may specify automatically for this set maximum intervals between the exams in the batch or batches. Moreover, the preferred period specified in step 160 may also be used to schedule the batch or batches according to step 190. In step 190 the set is then loaded for scheduling.

If in step 170 the operator decides to cancel the process, the operator can continue the process according to step 130. Again, the first selected procedure is accessed, and the system starts scheduling this single procedure.

If in step 170 the user decides to proceed the simultaneous scheduling process, the system arrives at step 200, shown in FIG. 1B. In step 200 a set is created. For this set, the user may specify the search period or preferred period of the first batch or treatment to be scheduled. Also the start time of the first exam may be entered. Preferably, the period and start time are those defined in step 160. Once the set is created in step 200, the exams listed in step 140 and not deleted in step 150, may be added in step 210 one by one in the chronological order as set in step 150. The loop of adding exams will be broken in test step 220 once all exams are added. As long as in step 220 there are still exams left to be added to the set as created in step 200, the operator can decide for each exam in step 230 whether the current exam has to be planned
1. on the same day as the previous exam, i.e. add the current exam to the batch of exams to be performed on the current day;
2. on a day different from the day of the previous exam, i.e. add the exam to a batch on a next day; or,
3. in a new treatment, to created in the set.

As such, according to a preferred embodiment, the system starts with an empty set in step 200, i.e. a set that contains no exams. In a first step 210, on request of the operator, a first exam is added to the empty set. After addition of the first exam in step 210, a second exam is added in step 210 etc., until all exams are added, as checked for in test rhombus 220. Whenever a new exam is to be added to the existing set, the operator has the choices mentioned above.

If the current exam has to be scheduled on the same day, the current exam is preferably added to the current batch and the operator may want to specify a time interval between the current and the previous exam in the order of hours or minutes. If that time interval is not specified explicitly by the user, the system may use a default time interval, e.g. the maximum interval that is still available on that day. Preferably, the time interval specifies the amount of time in minutes or hours between the end of the previous exam and the start of the current exam. In a more preferred embodiment,
1. a minimum time interval may be specified in the form of hh:mm, i.e. hours and minutes, preferably by a message “interval not less than”; and,
2. a maximum time interval may be specified in the form of hh:mm, i.e. hours and minutes, preferably by a message “interval not longer than”.

According to this option, the operator may also specify to overlap “pre-op” and “post-op”. The term “pre-op” is used for the time required for the patient to prepare himself for the exam. The term “post-op” is used for the time required for the patient to prepare himself after the exam. If a first exam and a second exam have to follow each other, where the patient has to prepare himself in a similar way, the operator may specify that “pre-op” and “post-op” may overlap, or even that there is no time needed between the end of the first exam and the start of the second exam.

If the operator specifies that the current exam has to start on a new day a new batch may be created according to step 250, and the default time intervals preferably remain the same. If the exam has to be scheduled on a different day, in step 260 the current exam is entered in the newly created batch and preferably a new start time for the current exam is indicated or given by the user. Preferably, the user may specify a start time in the form of HH:MM and an end time in the form of hh:mm. This means that the current exam has to start within the time interval HH:MM-hh:mm. The operator may preferably also specify an interval in days between this newly created batch and the previous batch. In a preferred embodiment, the operator may specify the minimum number of days between the previous and the current batch. This minimum may be e.g. zero. In a preferred embodiment, the user may analogously or simultaneously specify a maximum number of days between the previous batch and the current batch.

If the operator specifies a new treatment, this allows him to specify new time intervals in step 240. If it concerns a new treatment, in step 240 a new batch has to be created and a new preferred period may be indicated. The new time interval may be specified via a combo box, which gives the time period in a quite informal way, such as “two weeks after next week”. This informal specification may be transformed by the system in a more precise time interval or preferred period such as between “9 Sep. 2003” and “23 Sep. 2003”. In a preferred embodiment, the user may also specify here a start time in the form of HH:MM and an end time in the form of hh:mm. This means that the current exam within the new treatment has to start within the time interval HH:MM-hh:mm. If HH:MM is 09:00, i.e. 9 a.m., and if hh:mm is 17:00, i.e. 5 p.m., this means that the current exam has to start between 9 a.m. and 5 p.m. If a treatment comprises a first batch and a second batch, it may be suitable to specify a minimum or a maximum period between those two batches, or both a minimum and a maximum period.

As soon as all the exams are added to the set, the operator can proceed to step 265, as shown in FIG. 1C. In this step the operator can decide to
1. proceed to step 270;
2. finish the process and load the set for scheduling according to step 190 (FIG. 1A); or,
3. cancel the process and proceed with step 130 (FIG. 1A).

If the operator decides to proceed, he can scroll through the batches within step 270 and specify per batch grouping of resources. Therefore the operator can select a specific batch and indicate the resources such as persons (e.g. physician, nurse), room and equipment, etc. he wants to group for which exams. Grouping of procedures or exams, within one batch may be suitable for exams that can and may be performed one after the other.

In step 280, the operator decides to
1. proceed to step 290;
2. finish the process and load the set for scheduling in step 190 or,
3. cancel the process and proceed with step 130.

In step 290 the operator can scroll through the batches and optionally change the duration of the individual exams. Sometimes the duration of an exam has to be changed. For some exams, a standard duration may be defined, however, dependent on the age, physical or mental capabilities of the patient, it may be necessary to prolong the duration of the exam. The operator may also consider the standard duration of the exam too long for a specific patient and save the occupation of the resources by entering a shorter duration for the exam.

After finishing the optional adjustment of the exam duration in step 290, the operator can decide in step 300 to finish the process, such that the user interaction for this process is closed and the set may be loaded for scheduling according to step 190 (FIG. 1A). Alternatively, the operator may cancel the process and proceed with step 130 (FIG. 1A). At the end of the scheduling procedure of all the selected exams, preferably only one confirmation screen is shown. Consequently, the data that are requested in this screen have to be filled in only once and scheduling of all the selected exams is confirmed.

Finally, the output of the simultaneous scheduling process may look as follows:

1. Grouping set

2. Grouping treatment

3. Start between 2003.09.01 and 2003.09.08

4. Grouping batch

5. Start between 10:00 and 23:59

6. 00:30 Exam1

7. 00:00/02:00

8. 00:30 Exam2

9. Grouping treatment

10. Start between 2003.09.09 and 2003.09.09

11. Grouping batch

12. Start between 00:00 and 23:59

13. Exam3

14. 00:25 Subexam3.1

15. 00:35 Subexam3.2

16. 00:35 Subexam3.3

17. Days between 0/5

18. Grouping batch

19. Start between 00:00 and 23:59

20. Exam4

21. 00:25 Subexam4.1

22. 00:35 Subexam4.2

23. 00:35 Subexam4.3

Line 3 above, i.e. “Start between 2003.09.01 and 2003.09.08” specifies that the current treatment has to be planned in the period from 1 Sep. 2003 up to and including 8 Sep. 2003. Line 5 specifies that the batch, defined from line 4 to line 8 has to start within the time interval from 10 a.m. up to 1 minute before midnight on the same day. Line 6 specifies that the duration of the first exam, i.e. exam1, is 30 minutes. Line 7 specifies that between the end of exam1 and the start of next exam, i.e. exam2, there must be at least 00 hours and 00 minutes. This means that exam2 may follow exam1 immediately. This line 7 also specifies that the maximum time period between the end of exam1 and the start of exam2 must not exceed 02 hours and 00 minutes. Therefore, exam2 may follow immediately exam1, but must start within 2 hours after exam1 has been finished. Line 8 specifies that the duration of Exam2 is 00 hours and 30 minutes. Line 10 specifies that the second treatment, the definition of which started in line 9, has to occur between 9 Sep. 2003 and 9 Sep. 2003, which means that the second treatment must be planned on 9 Sep. 2003. Line 11 starts a new batch, and line 12 specifies that the exams within this batch all have to start between 0 hours of that day and one minute before midnight. Lines 13 to 16 specify that the third exam, i.e. Exam3 is composed of three sub-exams, which require 25, 35 and 35 minutes each respectively such that Exam3 requires 95 minutes. Line 18 then specifies that a new batch is defined, whereas line 17 specifies that the number of days between the previous batch and the current batch is not lower than 0 and must not exceed 5. This means that the current batch may be planned on the day following the day on which the previous batch is planned. Anyhow, the current batch must be planned on a day, which is not more than 6 days after the day on which the previous batch is planned.

### EXAMPLE

For convenience, in the example below, we designate the single exams with the letter E, followed by a number. P4 is a complex procedure, consisting of 4 single exams E7, E8, E9 and E10. The exams for patient A are given in the list below in bold face. We suppose that the system displays in step 100 the following list of procedures, most of which are single exams:

E3, E25, E33, E72, E2, E20, E5, E1, P4 (E7, E8, E9, E10)

We suppose that the above-mentioned exams and procedure have been validated by a physician, i.e. the physician decided that the single exams and exams E7, E8, E9 and E10 within procedure P4 may be performed on the specific patient.

The operator can browse through a list of validated procedures. He may restrict this list by specifying a performing department, just one procedure or one order type.

The operator may now, according to step 100 in FIG. 1A, select exam E3, i.e. the first selected procedure, which comprises only one exam. According to step 110, the system finds the other procedures E2, E1 and P4, related to the first procedure E3. These four procedures E3, E2, E1 and P4 are intended for one patient, which makes them related to each other. In step 120, the operator may select to continue with the first procedure only, i.e. E3, and proceeds with step 130. This single exam E3 may be instantaneously scheduled. As such, the operator may specify that the exam E3 must be scheduled on a working day between 9 a.m. and 4 p.m. within the next 10 days, except for Mondays. The scheduling system then looks for the next available time slot where the exam can be performed. This is a time slot on which all the resources, required for this exam, are available.

In step 120, the operator may select to group the first and other related procedures, such that according to step 140 a list of all the exams within the first and other procedures is displayed. This list looks as follows:

E3, E2, E1, E7, E8, E9, E10

According to this embodiment, the procedure P4 does not appear as such in this list. However, all exams, i.e. E7, E8, E9, E10, within procedure P4 do appear in the list, displayed according to step 140. According to step 150, exam E9 may be deleted, such that the list of exams to be grouped now looks like:

E3, E2, E1, E7, E8, E10

Further according to step 150, the chronological order of the exams may be changed, to obtain according to this example an order that looks as follows:

E1, E2, E10, E7, E8, E3

If E3 is a final consultation of the patient with the physician to discuss the results of the other exams, then it is logical that E3 is chronologically arranged as the last exam.

According to step 160, the operator is now expected to enter a preferred period and a start time. The period may be selected from a combo box that displays for example “next week”, “next month”, “two weeks after next week”, etc. This informal period is preferably transformed to a clear and unique start date and a clear and unique end date, which are preferably shown to the user of the system. The user may even want to change either the start date or the end date or both, to fit better the needs of the patient or those of the hospital. Preferably in step 160 also the start time of the first exam is specified, e.g. 10 a.m. or 10:00 for this example. More preferably, the user enters a period, referred to as time frame, with a start time and an end time, whereas the exam has to start within that entered time frame. The user now selects in step 170 to proceed with the normal process and reaches step 200 in FIG. 1B, where an empty set is created. Within the set, a first treatment is created. Preferably, this first treatment gets from the user a preferred date period, preferably specified by a start date and an end, according to this embodiment as defined in step 160 in FIG. 1A. Within this first treatment, a batch is defined. For this batch a start time may be defined, e.g. 10 a.m. or a time frame, specified by a start time and an end time, e.g. 09:30-17:20. According to this embodiment, the start time or time frame for the first batch in the first treatment is that as defined in step 160 in FIG. 1A. Once the set has a first treatment and a first batch, the first exam E1 can be entered in or added to the set, according to step 210. The earliest start time for E1 in this example is 10 a.m., as preferably defined in step 160 of FIG. 1A. At this point, E1 becomes now the previous exam, and according to step 220, the system finds the second exam E2, which becomes the current exam. The test at 220 gives that not all exams are added, and the system proceeds to test 230. For the current exam E2, the user has to specify whether he wants to plan the exam within the day of the first exam E1, such that E2 may be entered in the current batch. If the user decides “same day”, the current exam E2 will be entered in the current batch. The user may now want to specify the time gap between the end of the first exam E1 and the start of the second exam E2. The system may give as default that the minimum time gap is 00:00, i.e. 0 hours and 0 minutes, and maximum time gap is such that the second exam E2 can start at the end of the day, i.e. at 23:59. As such, the earliest moment that the second exam E2 can start, is at the end of E1, and the latest moment that the second exam E2 can start is at 23:59. The time gap is thus the time between the end of the previous exam, here E1, and the start of the current exam, here E2. If E1 is an exertion test and E2 is an X-ray image of the thorax of the patient, it may be necessary that the minimum time gap between E1 and E2 is 2 hours. In step 210, the exam E2 is then added to the set, more specifically to the first batch. In step 220, the system can take E10 as the current exam and finds that step 230 can be executed. If the user decides here that the current exam E10 has to be executed on a new day, i.e. a day different from the day on which exams E1 and E2 have to be executed, then the system will proceed to step 250 and will create a new batch. For this new batch, the user may want to specify a date interval in days. More preferably the user specifies a minimum date interval, which may be 0 days, such that the newly created batch has to start on the day directly following the previous batch. Analogously the user may specify a maximum date interval, i.e. the maximum number of “empty” days between the previous batch and the current batch. According to this example, the user may specify that the minimum date interval between the first batch, containing exams E1 and E2, and the second batch, for containing exam E10, must be 0. He may also specify that the maximum date interval is 5 days. In another example, the minimum date interval between the two subsequent batches may be 2 days, and the maximum date interval 4 days. If the user wants to specify that the current batch must occur a fixed number of days after the previous batch, then the maximum and minimum date interval can be chosen to be equal.

Since E10 defines a new batch, starting on a new day, it is preferred that for E10 or for this new batch an earliest start time or a time window with an earliest start time and latest end time is given. Next exams E7 and E8 may be added to the batch containing E10, such that E10, E7 and E8 will be performed on one day. If for exam E3 a new treatment is selected, then according to step 240 a new batch is created and for the treatment a preferred date period may be specified, preferably by a start date and an end date.

At this point, the test 220 will indicate that all exams are added and the system proceeds with step 265 in FIG. 1C. If the user now selects to proceed to step 270 he may group the resources within each batch. E1 and E2 form a first batch and E10, E7, E8 form a second batch. If E1 and E2 use identical resources, e.g. one radiologist, one nurse, one specific CT scanner, then exams E1 and E2 may be grouped. Grouping of resources is preferably restricted to exams within one batch, having exams to be started within one day. If exams may be grouped this way, and the minimum time gap between these exams is zero, then these exams may be scheduled directly following each other. The batch E10, E7, E8 may lead to the following grouping of resources:

E10, E7

E7, E8

E10, E7, E8

The last grouping is special. This system first finds out that E7 may be grouped with E10. Afterwards, the system finds out that E8 may be grouped with E7, preferably without searching for grouping between E8 and E10.

Resources may be grouped in resource groups. For example, if the hospital has 3 CT scanners and 2 MR scanners and 5 echographical systems with high resolution and 3 echographical systems with low resolution, it is possible to define the following resource groups:

1. CT

2. MR

3. Echo low res

4. Echo high res

Also radiologists may be entered in a resource group.

The notion of a resource group, gives more flexibility for selecting a free time period for that kind of resource.

In a last step 290, the duration of each of the exams in the set may be changed, as needed for the specific patient.

After all preferred date periods, time windows, date intervals and time gaps have been defined for the exams, batches and treatments within the set, the system may start the scheduling process, to obtain a solution that fulfils all constraints.

Having described in detail preferred embodiments of the current invention, it will now be apparent to those skilled in the art that numerous modifications can be made therein without departing from the scope of the invention as defined in the appending claims.

1. A method for grouping a plurality of exams for a patient comprising the following steps:
selecting a first exam;
selecting at least one other exam, related to said first exam;
is characterised in that the method further comprises the step of defining a time relation between said first exam and said other exam.

2. The method according to claim 1, further comprising the steps of:
assigning to said first exam an earliest start time; and,
optionally assigning to said first exam a latest start time, not earlier than said earliest start time.

3. The method according to any one of the previous claims, further comprising the steps of:
assigning to said first exam an earliest start date; and,
optionally assigning to said first exam a latest start date, not earlier than said earliest start date.

4. The method according to any one of the previous claims, further comprising the steps of:
assigning to said other exam a second earliest start time; and,
optionally assigning to said other exam a second latest start time, not earlier than said earliest second start time
optionally assigning to said other exam a second earliest start date; and,
optionally assigning to said other exam a second latest start date, not earlier than said second earliest start date.

5. The method according to any one of the previous claims, further comprising the steps of:
defining a batch for a plurality of exams to be started during one day;
entering in said batch said first exam and said other exam, for execution chronologically after said first exam;
assigning to said second exam a minimum time gap belween the end of said first exam and the start of said second exam; and,
optionally assigning to said second exam a maximum time gap between the end of said first exam and the start of said second exam.

6. The method according to claim 5, further comprising the steps of:
defining a treatment for entering a plurality of batches to be started on subsequent days;
entering in said treatment said batch as a first batch;
assigning to said treatment an earliest start date; and,
optionally assigning to said treatment a latest end date, not earlier than said earliest start date.

7. The method according to claim 6, further comprising the steps of:
entering in said treatment a second batch, having at least one of said other exams;
assigning to said second batch a minimum date interval between said first batch and said second batch;
optionally assigning to said second batch a maximum date interval between said first batch and said second batch.

8. The method according to any one of the previous claims, comprising the step of arranging said first and other exams in a chronological order.

9. The method according to any one of the previous claims, comprising the step of deleting at least one other related exam.

10. A system for grouping a plurality of exams for a patient comprising:
means for selecting a first exam;
means for selecting at least one other exam, related to said first exam;
is characterised in that said system comprises means for defining a time relation between said first exam and said other exam.
